(19) United States
(12) Patent Application Publication
(10) Pub. No.: US 2024/0294077 A1
(43) Pub. Date: Sep. 5, 2024

(54) VEHICULAR POWERED CHARGE PORT ACTUATOR AND PANEL ASSEMBLY WITH ICE BREAKING CAPABILITIES

(71) Applicant: Magna Mirrors of America, Inc., Holland, MI (US)

(72) Inventors: Anthony J. LaCross, Hastings, MI (US); Austen C. Peterson, Hudsonville, MI (US); Andrew M. Neumann, Jenison, MI (US); Adam S. McCain, Petoskey, MI (US)

(21) Appl. No.: 18/443,744

(22) Filed: Feb. 16, 2024

Related U.S. Application Data
(60) Provisional application No. 63/499,752, filed on May 3, 2023.
(60) Provisional application No. 63/488,240, filed on Mar. 3, 2023.

(51) Int. Cl. B60L 53/16; B08B 7/02; B60S 1/66; E05F 15/616

(52) U.S. Cl. CPC B60L 53/16; B60S 1/66; E05F 15/616; B08B 7/02; E05Y 2201/638

(57) ABSTRACT

A vehicular charge port closure system includes a cover panel disposed at a vehicle. The cover panel is movable between a closed position, where the cover panel conceals a charge port of the vehicle, and an opened position, where the cover panel is positioned to allow access to a charging connector of the charge port. A deployment mechanism is operable to move the cover panel between the closed and opened positions. An ice breaking mechanism is disposed at the cover panel and, when ice is present at the peripheral edge of the cover panel, the ice breaking mechanism is operable to break the ice from the peripheral edge of the cover panel so that the cover panel is movable from the closed position toward the opened position.

### CROSS REFERENCE TO RELATED APPLICATIONS

The present application claims the filing benefits of U.S. provisional application Ser. No. 63/499,752, filed May 3, 2023, and U.S. provisional application Ser. No. 63/488,240, filed Mar. 3, 2023, which are hereby incorporated herein by reference in their entireties.

### FIELD OF THE INVENTION

The present invention relates to a charge port or fuel port of a vehicle.

### BACKGROUND OF THE INVENTION

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located at the side of the vehicle and is manually pivotable between the closed and opened positions.

### SUMMARY OF THE INVENTION

A vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port and positioned to allow access to a charging connector of the charge port. A deployment mechanism is operable to move the cover panel between the closed position and the opened position. The system includes an ice-breaking mechanism that, when the deployment mechanism fails to move the cover panel from the closed position and with ice build-up present at a peripheral edge of the cover panel, is operable to at least partially remove or break the ice build-up from the peripheral edge of the cover panel so that the cover panel is movable from the closed position toward the opened position.

Optionally, the ice-breaking mechanism includes (i) an output element disposed at least partially outboard of the peripheral edge of the cover panel and (ii) an electrically operable actuator that is electrically operated to move the output element. With the cover panel in the closed position, the output element is movable between a retracted position, where the output element is disposed inboard of an outer side of the cover panel, and an extended position, where the output element is moved from the retracted position and toward the outer side of the cover panel. The electrically operable actuator is electrically operated to move the output element from the retracted position toward the extended position so that the output element engages and breaks the ice as the output element moves toward the extended position.

Optionally, the ice-breaking mechanism includes a vibration device that is electrically operable to impart vibratory movement of the cover panel to break the ice. The vibration device, when ice is present at an outer surface of the cover panel that limits movement of the cover panel from the closed position toward the opened position, is electrically operated to impart vibration of the cover panel to at least partially loosen or break or remove the ice from the cover panel so that the cover panel is movable from the closed position toward the opened position.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular electric charging system;

FIG. 2 is a perspective view of a charge port of the vehicular electric charging system, with a cover panel in a closed position relative to a base portion;

FIG. 3 is a plan view of an ice-breaking mechanism of the charge port of FIG. 2;

FIG. 4 is a plan view of a spiral cam of the ice-breaking mechanism;

FIGS. 5A-5C are views of the charge port of FIG. 2 as the ice-breaking mechanism is operated between a recessed position and an extended position to remove ice build-up at the outer surface of the cover panel and move the cover panel from a flush position to a partially extended position;

FIG. 6 is a plan view of another charge port with an ice-breaking mechanism in a retracted position;

FIG. 7 is a plan view of the charge port of FIG. 6 with the ice-breaking mechanism in the extended position and moved relative to the cover panel to remove ice build-up at the peripheral edges of the cover panel;

FIG. 8 is a plan view of another charge port with an ice-breaking mechanism having a pivotable door, with the cover panel in the closed position relative to the base portion and the pivotable door in a retracted position relative to the cover panel;

FIGS. 9 and 10 are sectional views of the cover panel in the closed position relative to the base portion and the pivotable door moved to an extended position relative to the cover panel via an actuator of the ice-breaking mechanism;

FIGS. 11 and 12 are perspective views of a charge port of another vehicular electric charging system, with a cover panel of the charge port in a closed position; and

FIGS. 13-15 are views of different vibration motors configured for use with the charge port of FIGS. 11 and 12 to impart vibration of the cover panel and/or outer surface of the vehicle at and around the charge port to remove and/or loosen ice build-up at the outer surface of the cover panel.

### DESCRIPTION OF THE PREFERRED EMBODIMENTS

A vehicular electric charging charge port opening system operates to open and/or close a power charge flap or panel of an electrically powered vehicle that covers a charging connector configured to electrically connect with an electrical connector of a charging wand to charge batteries of the electrically powered vehicle. Aspects of the power charge flap described herein may also be suitable for use with a fuel port cover for covering a fuel filler port or opening of a vehicle that is configured to receive a nozzle that delivers fuel (e.g., gasoline) to a fuel tank of the vehicle via the fuel port.

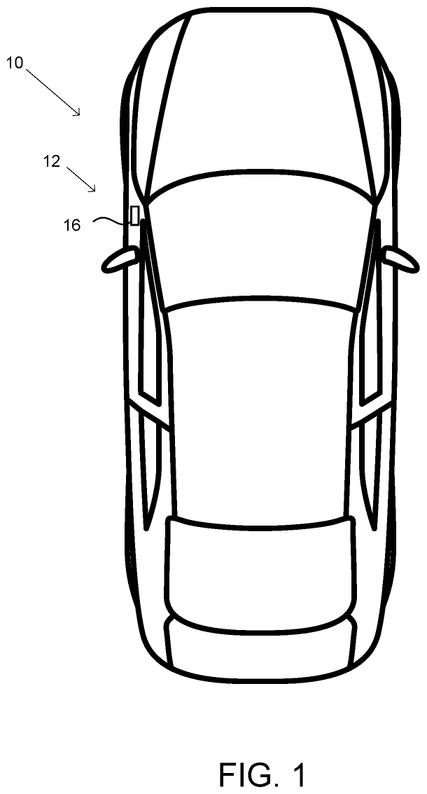

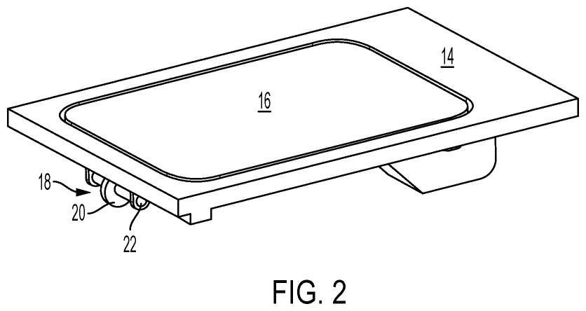

Referring now to the drawings and illustrative embodiments depicted therein, a vehicle 10 (e.g., an electric vehicle or EV, or a plug-in hybrid vehicle or PHEV) includes an electrical charging system or charge port 12 that includes a base portion or bracket 14 and a cover panel or flap 16 (FIGS. 1 and 2). For example, the panel 16 is pivotably mounted at the vehicle or the base portion 14 and has an outer surface that, when the panel 16 is in a closed position, corresponds with and/or is substantially flush with an outer surface of the exterior panel(s) of the vehicle 10 at and around the charge port 12 of the vehicle. When in the closed position, the cover panel 16 conceals a charging connector (not shown) of the charge port 12 that is configured or operable to electrically connect with an electrical connector or charging wand (not shown) of a charging station or system to charge batteries of the vehicle 10. When in an open position, the cover panel 16 may be moved relative to the base portion and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector.

As shown in FIG. 1, the charge port 12 may be disposed along a side of the vehicle 10 and, when the cover panel 16 is in the closed position, the exterior surface of the panel 16 is substantially flush with and corresponds to the exterior surface of the vehicle 10 and/or the base portion 14 at or surrounding the charge port 12. The charge port 12 may be disposed at any suitable position at the exterior of the vehicle. For example, the charge port 12 may be disposed at the front or rear fender or bumper of the vehicle. Optionally, the charge port 12 may be concealed behind an exterior feature of the vehicle 10, such as a manufacturers emblem, a portion of a headlight or taillight, a license plate bracket, or the like, where the closure system enables movement of the exterior feature between the closed and opened positions.

When the cover panel 16 is in the closed position, the cover panel 16 may at least partially compress a sealing element or gasket between a rear or interior side or an edge region of the cover panel 16 and the base portion or side of the vehicle surrounding the charge port 12 to protect the connector portion and limit or preclude moisture and contaminants from entering the charge port 12 when the cover panel 16 is closed. For example, the sealing element may be disposed at the interior side of the cover panel 16 or at the base portion and configured to at least partially circumscribe the connector when the cover panel 16 is closed.

The cover panel 16 is movable between the closed position and the opened position via operation of an electrically operable actuator or primary actuator, which may be electrically operated to move the cover panel in response to a user input. For example, the primary actuator may deploy the cover panel 16 in response to a user input at a key fob associated with the vehicle, a button or sensor at the exterior surface of the charge port 12 or vehicle, or a button at the interior of the vehicle cabin. When actuated, the primary actuator (such as an electrically operable motor of the actuator) operates to move the cover panel from the closed position toward the opened position, and the cover panel may move relative to the base portion in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication No. US-2023-0191926 and/or U.S. patent application Ser. No. 18/476,632, filed Sep. 28, 2023 (Attorney Docket DON10 P4918), and/or U.S. patent application Ser. No. 18/419,751, filed Jan. 23, 2024 (Attorney Docket DON09 P5045), and/or U.S. provisional application Ser. No. 63/493,327, filed Mar. 31, 2023, U.S. provisional application Ser. No. 63/493,409, filed Mar. 31, 2023, U.S. provisional application Ser. No. 63/4978,454, filed Apr. 21, 2023, U.S. provisional application Ser. No. 63/495,315, filed Apr. 11, 2023, U.S. provisional application Ser. No. 63/495,619, filed Apr. 12, 2023, and/or U.S. provisional application Ser. No. 63/496,031, filed Apr. 14, 2023, which are hereby incorporated herein by reference in their entireties.

An actuator with high torque output may be preferred to actuate a charge port door in the closed position to compress the seal and to open the door against obstructions like ice build-up at the exterior surface of the cover panel. Further, rapid opening of the door is desired to avoid wait times for the user when opening the door to charge the vehicle.

Optionally, the cover panel 16 may be manually movable between the closed position and the opened position. For example, a latch mechanism may releasably retain the cover panel 16 in the closed position. When a user manually compresses the cover panel or moves the cover panel 16 inward toward the base portion from the closed position further from the opened position, the latch mechanism releases the cover panel and a biasing element may urge the cover panel 16 at least partially toward the opened position. With the cover panel released by the latch mechanism, the cover panel is further manually movable toward the opened position.

Traditionally, charge ports with cover panels that are movable between closed and opened positions via use of an actuator fail to move the cover panel from the closed position toward the opened position when ice build-up is present at the outer surface of the cover panel. That is, the electrically operable motor of traditional charge ports is unable to supply high enough torque to the cover panel to overcome the resistance load at the cover panel. A common solution is to provide an electrically operable motor with a much higher torque output suitable to break through ice. However, these motors with higher torque outputs may be costly or require additional components. Manual deployment of the cover panel 16 may also be hindered by ice build-up at the outer surface of the cover panel.

As described further below, the charge port 12 may include a secondary or supplementary actuator for providing additional opening force at the cover panel to overcome resistance caused by ice buildup at the outer surface of the cover panel and/or to provide a more rapid opening sequence of the cover panel. For example, and referring to FIGS. 2-5C, the charge port 12 includes a power charge flap opening assist actuator or secondary actuator or ice-breaking mechanism 18 that is configured to, when operated, assist in moving the panel 16 from the closed position toward the opened position. The secondary actuator 18 may be operated to assist in moving the panel 16 each time the primary actuator is operated to move the panel 16, or the secondary actuator 18 may be operated in the event that the primary actuator has failed to move the panel 16 toward the open position or in response to a user actuatable input. For example, ice build-up at the exterior surface of the cover panel 16 may provide added resistance to opening the cover panel that prevents the primary actuator from being able to open the cover panel 16. The secondary actuator or ice-breaking mechanism 18 may assist in overcoming the added resistance, such as by providing additional torque to the opening force of the primary actuator or by extending a portion of the cover panel or an ice breaking tool that breaks or loosens the ice build-up to allow the primary actuator to open the cover panel 16.

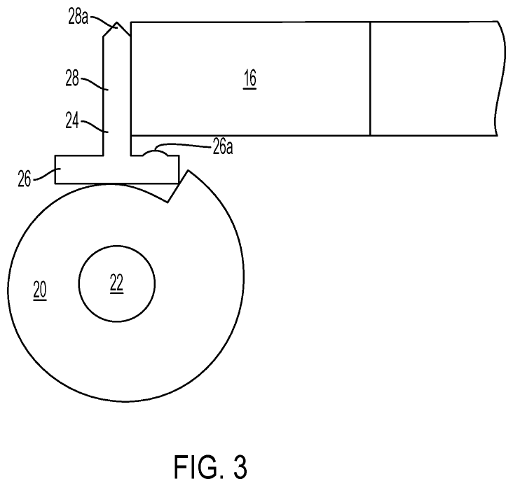

As shown in FIG. 3, the secondary actuator 18 may include a cam 20, such as a spiral-shaped cam (e.g., an Archimedes spiral) or a lobe-shaped cam, that is mounted at the base portion 14 and that pivots or rotates about an axis of rotation when the secondary actuator 18 is operated to extend an ice knife or pin 24. For example, the cam 20 may be mounted at the base portion 14 via a pivot pin 22 that extends along a longitudinal axis of the cam 20 to define the axis of rotation. When the actuator 18 is operated, an electrically operable motor may rotatably drive the cam 20 to impart movement of the pin 24 relative to the cover panel 16 and the base portion 14.

The ice knife or sled or pin 24 is disposed adjacent the cam 20 and extends from the cam 20 toward the outer surface of the vehicle along at least a portion of a peripheral edge of the cover panel 16. The ice pin 24 engages and rides along an outer surface of the cam 20 so that, as the cam 20 rotates, the pin moves along the outer surface of the cam 20 and moves perpendicular to the pivot axis or pin 22 of the cam 20 along the peripheral edge of the cover panel 16 (i.e., inward and outward from the cam relative to the cover panel) according to changes in the radius of the cam 20 (i.e., the thickness of the cam between the pivot pin and the outer surface at the portion of the outer surface engaging the ice pin). In other words, rotation of the cam 20 during operation of the secondary actuator 18 causes the ice pin 24 to move inward and outward relative to the side of the vehicle and at or along the outer edge of the closed cover panel 16. For example, as the pin 24 moves outward along the outer edge of the cover panel, the pin 24 may move linearly and substantially perpendicular to the peripheral edge and outer surface of the cover panel 16.

The ice pin 24 includes a first portion 26 that engages and rides along the outer surface of the cam 20 and a second portion 28 that extends from the first portion and along the peripheral edge of the panel 16. The second portion 28 may include a hardened and/or sharpened end point or edge 28a so that, as the ice pin 24 moves outward from the base portion 14, the sharpened edge 28a may engage the ice build-up at the exterior surface of the cover panel 16 and break or cut through the ice build-up. The first portion 26 may include a ridge or protrusion 26a so that, as the ice pin 24 moves along the outer surface of the cam and the second portion 28 breaks through the ice at the outer surface of the cover panel 16, the protrusion 26a may engage the inner surface of the cover panel 16 and provide a force against the cover panel 16 to move the cover panel 16 toward the opened position. In the illustrated example of FIG. 3, the second portion 28 extends from the first portion 26 to define a substantially T-shaped ice pin 24.

A radius of the cam 20 between the pivot axis and the portion of the outer surface engaging the pin 24 changes as the cam 20 rotates to move the pin 24 substantially perpendicular to the outer surface of the cam and away or toward the axis of rotation according to rotation of the cam. Optionally, the pin may engage the inner side or surface of the cover panel and apply force directly to the cover panel to overcome the added resistance at the outer surface of the cover panel. Thus, the pin does not extend along the peripheral edge of the cover panel and is able to help overcome resistance that is not localized to the position of the secondary actuator along the peripheral edge of the cover panel. Optionally, the surface of the cam itself may engage the inner side of the cover panel and apply force directly to the cover panel to overcome the added resistance at the outer surface of the cover panel. The cam may be rotatably driven by any suitable input, such as by an electrically operable motor, or by a user pulling on a cable or cord coupled to the cam.

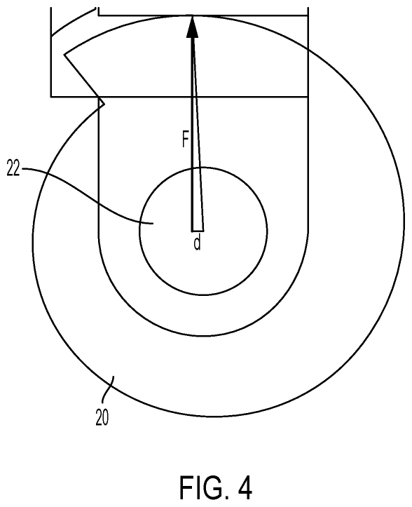

In the illustrated example, such as shown in FIG. 4, the cam 20 comprises an Archimedes spiral shape. Thus, as the cam 20 rotates, the torque provided by the rotation of the cam (e.g., from the electrically operable motor) is translated into linear force through the pin 24 via the change in radius of the cam 20 during rotation.

In other words, the force of the cam is along the normal force at the tangent point of the interface between the outer surface of the cam and the pin. This force passes through or near the center of rotation and the closer the normal force is to the center of rotation, the greater the force output of the mechanism. Because torque may be equal to the normal force multiplied by distance between the normal force and axis of rotation, the normal force output through the pin of the secondary actuator may be equal to the torque input divided by distance between the normal force and the axis of rotation. The distance between the normal force and the axis of rotation is dependent upon the amount of change in radius around the cam, and a smaller change yields a smaller change in distance between the normal force and the axis of rotation and a greater normal force. Since the secondary actuator 18 does not fully open the cover flap and instead provides an emergency or backup force, the change in radius can be relatively small.

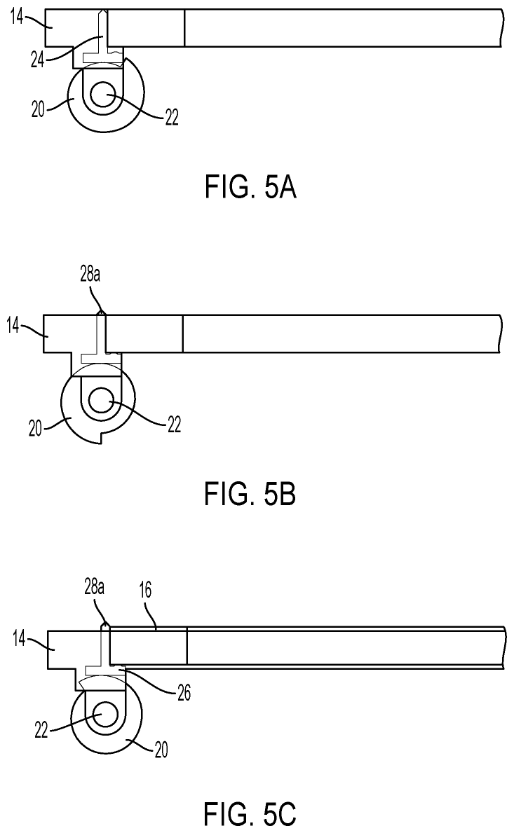

FIGS. 5A-5C depict the cover panel 16 and the secondary actuator 18 as the secondary actuator 18 is operated to break ice build-up at the outer surface of the cover panel 16 and move the cover panel 16 from the closed and flush position to a partially extended position. In FIG. 5A, the cover panel 16 is in the flush state and the pin 24 is retracted along the peripheral edge of the cover panel 16. As the cam 20 rotates (e.g., clockwise in FIGS. 5A-5C), the first portion 26 of the pin moves along the outer surface of the cam 20 and the pin 24 moves substantially perpendicular to the axis of rotation and outward relative to the base portion 14 (e.g., upward in FIGS. 5A-5C) due to the increasing radius of the cam 20 at the cam-pin interface as the cam rotates. The pin 24 moves outward so that the edge 28a of the second portion 28 is exposed exterior the cover panel 16 to engage and break ice build-up at the outer surface of the cover panel 16 (FIG. 5B).

That is, as the cam 20 initially rotates, only the ice knife 24 is being forced outward and the edge 28a is forced out of a gap between the cover panel 16 and the base portion 14 or body panel of the vehicle with high pressure. The pin 24 does not need to be metal and/or sharp. Optionally, the pin 24 may be hard plastic or soft rubber. For example, a rubber strip would allow the strip to flex as it is pushed out and flexing would aid in breaking the ice by forcing the ice to release from the strip, rather than forcing through the ice, similar to twisting the ice to release it.

As shown in FIG. 5C, as the pin 24 moves toward the cover panel 16, such as after the edge 28a is exposed exterior the panel, the first portion 26 of the pin engages the cover panel 16 and urges or moves the cover panel from the closed position toward the opened position to a partially extended position. The cover panel 16 may then be fully opened, such as manually by the user or via actuation of the primary actuator. The cover panel may only be pushed out as far as is required to access the cover panel to move it to the fully opened position. The pin may be biased or spring-loaded such that, when the cam is further rotated or rotated in the reverse direction (so that the cam has a smaller radius at the cam-pin interface), the pin returns toward and to its retracted state.

The power charge flap opening assist actuator thus operates as a secondary actuator to help the charge flap open in the event that it fails to open through normal means. The secondary actuator may be operated electrically when the driver pushes a button located within the cab of the vehicle or automatically when the vehicle senses that the primary actuator is unable to open the flap. For example, following an activation of the primary actuator, a sensor at the charge port may determine that the cover panel is still in the closed position and thus the secondary actuator may be operated responsive to determination that the cover panel is in the closed position following the activation of the primary actuator. The secondary actuator can force through ice build-up that prevents the flap from opening. Optionally, the secondary actuator may operate every time the primary actuator operates. Further, the secondary actuator may operate manually when a cable is pulled and the pull cable may be in the vehicle cabin, in the vehicle trunk, or accessible at a wheel well and/or door jamb as a fail-safe.

When the secondary actuator is operated, torque is applied and the spiral cam on the drive shaft rotates. Torque may be applied manually through the use of a pull cable and/or through the use of an electric motor (with or without an attached gear train).

The secondary actuator allows for the separation of the functions of the power charge flap. A smaller, simpler, and/or less costly primary actuator may be used to open the flap under normal circumstances. The primary actuator maybe smaller, simpler, and/or less costly because it would no longer be required to break ice or provide high enough torque to overcome added resistance. The ice breaking mechanism provides a small, simple, and/or modular ice break or secondary actuator that may be applied in any situation where the feature is desired. The dedicated ice break actuator yields a specialized assembly with a much greater ability to break ice since that is its primary purpose.

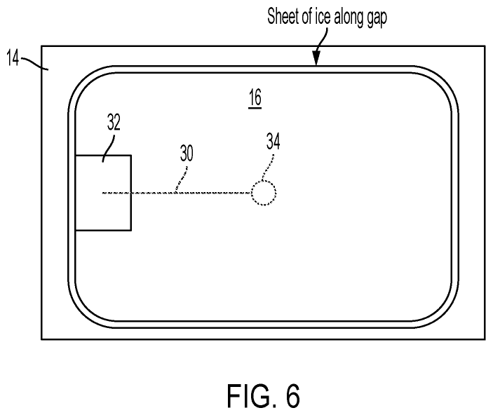

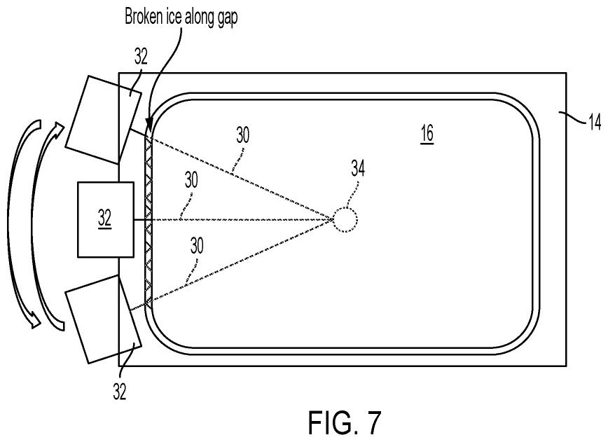

Optionally, the charge port may include a mechanism that moves along the peripheral edge of the cover panel to remove ice buildup at the peripheral edge. For example, and referring to FIGS. 6 and 7, the charge port 12 may include a charge flap ice cutter that provides a deployable string or cord or element 30 that is capable of slicing through ice build-up around the gap between the cover panel 16 and the base portion 14 or body panel of the vehicle. That is, when ice builds up at the gap between the peripheral edge of the cover panel 16 and the base portion 14 or body panel of the vehicle, the user may grasp a trap door or tab 32 coupled to the string or cord 30 and pull the tab 32 to extend the deployable cord 30 into and through the gap between the cover panel 16 and the base portion 14. With the cord 30 passing through the gap, the user may hold the tab 32 to maintain tension in the cord 30 and move the cord 30 around the cover panel 16 to remove the ice build-up. When not in use, the tab 32 may couple to the cover panel 16 with the cord 30 retracted behind the cover panel 16. For example, the tab 32 may comprise a removable portion of the cover panel 16 and/or the tab may attach to the cover panel 16, such as snap attach or magnetically attach at the exterior surface of the cover panel, such as at a recessed portion of the exterior surface of the cover panel so that an exterior surface of the tab 32 may be substantially flush with or correspond to the exterior surface of the cover panel 16 when the tab 32 is accommodated at the recessed portion.

Thus, the ice cutter is movable between a retracted position (e.g., FIG. 6), where the tab 32 is coupled to or received at the cover panel 16 and the cord 30 is retracted behind the cover panel 16, and an extended position (e.g., FIG. 7), where the tab 32 is pulled laterally outboard from the cover panel 16 and vehicle body panel to extend the cord 30 into the gap between the cover panel 16 and the base portion 14 or body panel of the vehicle. When in the extended position, the tab 32 and cord 30 are manually movable along the peripheral edge of the cover panel 16 to remove or break ice build-up. The cord 30 may extend from a return reel or spool 34 that biases the cord 30 toward the retracted position and that helps to maintain tension in the cord 30 as the tab and cord are moved to remove ice build-up. Thus, the cord 30 is attached to the tab 32 at a first end of the cord 30 and to the spool 34 at an opposite second end of the cord 30. The spool 34 may define a pivot center for the cord and tab around the cover panel.

In other words, the ice cutter is a deployable string capable of slicing through ice build-up around the gap between the power charge door and the vehicle sheet metal or base portion. Once deployed to the outside of the vehicle, the string is traced around the perimeter (or a portion of the perimeter) to cut/shear the ice. The string can be deployed via the tab or trap door. The string is tethered to the inside of the charge flap door. The string is made of a high strength woven or braided nylon/polyester material (or similarly strong and durable material that does not risk damage to the cover panel 16 when moved about the peripheral edge). The string can be returned to its un-deployed state via a coil spring in a spool or reel mechanism, like a badge reel. Thus, the user has full control of the ice breaking action in a fully manual approach (fail-safe) as the ice cutter provides a simple mechanism with no electrical operation required. The trap door or tab may comprise any suitable styling or attachment method that can be accessed when there is ice present.

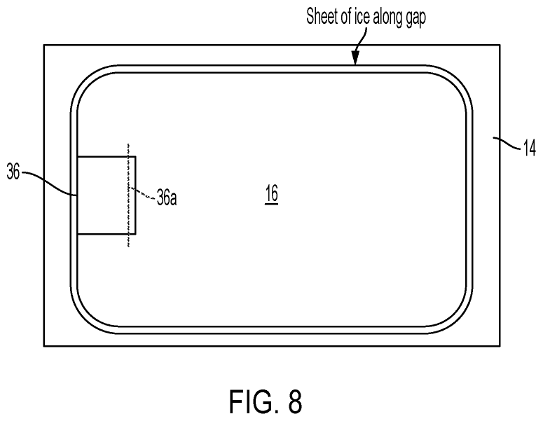

Optionally, a portion of the cover panel may be movable relative to the rest of the cover panel to loosen and/or break up ice build-up at the outer surface of the cover panel. For example, and referring to FIGS. 8-10, the charge port 12 may include a charge flap trap door ice breaker that includes an actuator that, when electrically operated, moves a portion of the cover panel, such as a tab or trap door or pivotable door 36 integrated with the cover panel 16, relative to the cover panel 16 to break ice build-up along the perimeter or peripheral edge of the cover panel and reduce resistance to the primary actuator. The pivotable door 36 may comprise a pivotable portion of the cover panel 16 along the peripheral edge of the cover panel and that is pivotable relative to the cover panel 16. In the illustrated example of FIG. 8, the pivotable door 36 pivots about a pivot axis 36a that is substantially parallel to the peripheral edge and the outer surface of the cover panel 16. The peripheral edge of the pivotable door 36 may be aligned with and substantially overlap with the peripheral edge of the cover panel 16 to provide a covert appearance and to move ice away from the edge of the cover panel 16 when the pivotable door 36 is opened.

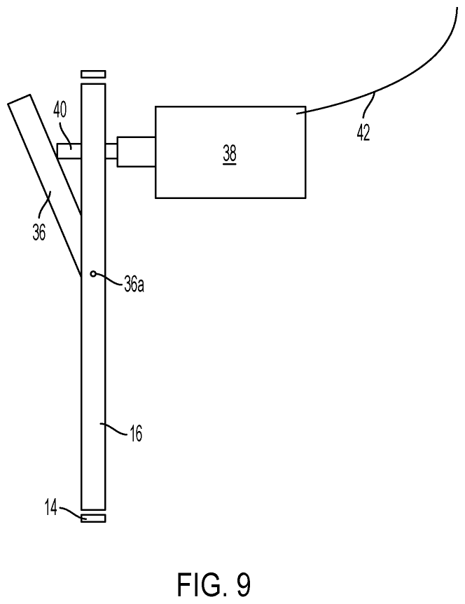

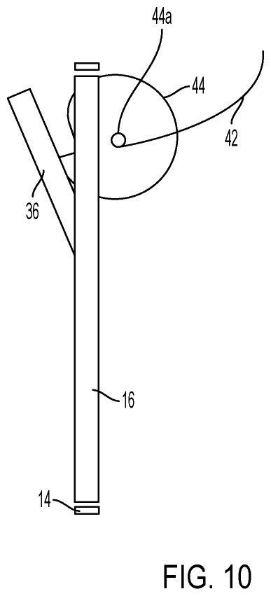

The pivotable door 36 is movable relative to the cover panel 16 between a retracted position (FIG. 8), where the door 36 is substantially flush with and corresponds to an outer surface of the cover panel 16, and an extended position (FIGS. 9 and 10), where the actuator moves the pivotable door 36 about the pivot axis 36a to pivot the door 36 outward from the cover panel 16. When the door 36 is in the extended position, a gap or grasping portion is formed between the door 36 and the outer surface of the cover panel 16 so that the user may grasp the door 36 and/or cover panel 16 and manually move the cover panel 16 toward and to the opened position.

As shown in FIG. 9, a linear actuator 38 may include a plunger or extending portion 40 that moves linearly relative to the actuator to move the pivotable door 36 between the retracted position and the extended position. That is, the plunger 40 engages the inner surface of the door 36 and, as the plunger 40 is extended from the actuator 38, the door 36 pivots relative to the cover panel 16 from the retracted position toward the extended position. A manual pull string 42 may be coupled to the actuator for manually actuating the plunger 40 to move the pivotable door 36. For example, the pull string 42 may be accessible to the user in the cabin of the vehicle, the trunk of the vehicle, at a wheel well of the vehicle, at a door jamb of the vehicle, or at the exterior surface of the body panel of the vehicle. The actuator 38 may comprise a spring and damper detent system coupled to the manual pull string 42 for extending the plunger 40 without damaging the motor of the actuator 38. That is, when the user manually extends the plunger 40, movement of the plunger 40 may be decoupled from the motor of the actuator. The linear actuator may operate to move the plunger in the opposite direction to retract the door 36 (via attachment of the end of the plunger at the door 36), or the door may be biased toward its closed position, such that the door returns to its closed position when the plunger is retracted. The linear actuator may utilize aspects of the actuators described in U.S. Publication Nos. US-2024-0035318; US-2023-0027125 and/or US-2022-0341226, and/or U.S. patent application Ser. No. 18/416,029, filed Jan. 18, 2024 (Attorney Docket DON08 P5040), U.S. patent application Ser. No. 18/414,533, filed Jan. 17, 2024 (Attorney Docket DON08 P5038) and/or U.S. patent application Ser. No. 18/476,632, filed Sep. 28, 2023 (Attorney Docket DON10 P4918), which are all hereby incorporated herein by reference in their entireties.

Optionally, and such as shown in FIG. 10, the actuator may be operable to pivot a torsion cam, such as a spiral-shaped or a lobe-shaped cam 44 that engages the inner surface of the pivotable door 36 and that pivots the door 36 as the cam 44 rotates and the radius of the cam 44 at the portion engaging the door increases. That is, the increasing radius of the cam 44 during rotation of the cam 33 causes the door 36 to pivot relative to the cover panel 16. The pull string 42 may be coupled directly to the cam 44 or to the pivot axis 44a of the cam 44 to enable manual rotation of the cam 44 when pulled by the user.

That is, the trap door ice breaker utilizes a small trap door and pivot integrated into the main charge door that is used to break ice along a portion of the door's perimeter. The actuator pushes the trap door outward, away from the vehicle, to break the ice accumulated along the panel gap between the base portion or body panel and the cover panel. The actuator may linearly push the trap door out or the actuator may rotate the trap door with a cam and follower mechanism. Thus, the actuator applies a linear force or a torque to the trap door. The mechanism pushes the trap door toward the opened position, creating a finger hook so that the cover panel can be opened the rest of the way manually via grasping of the trap door. The actuator may also include a manual release for a small spring/damper detent system that pushes the trap door open without help from the electric motor. The manual release allows for function of the ice breaking method in the event the actuator's electronics fail.

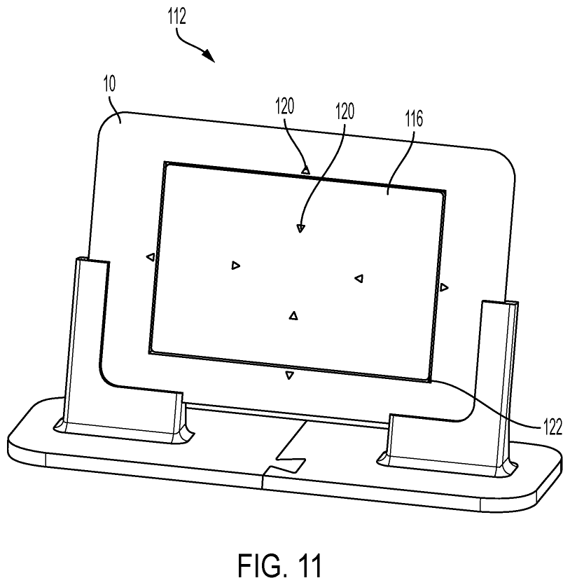

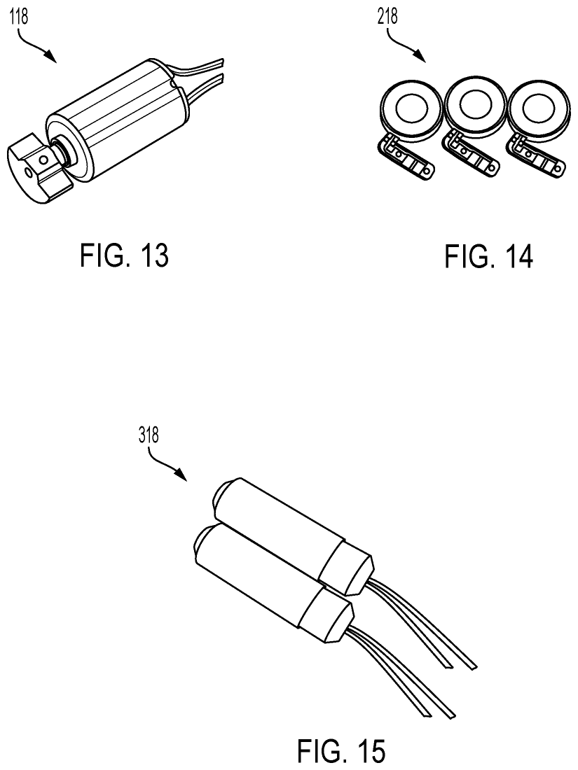

Optionally, the charge port may include an electrically operable unit at or near the cover panel for loosening and/or breaking up ice at the cover panel prior to opening the cover panel. For example, and referring to FIGS. 11-15, a charge port 112 configured to be mounted at the vehicle 10 includes one or more vibration units or devices or modules 114 at or near the cover panel 116 or outer surface of the vehicle 10 surrounding the cover panel 116. The vibration device or module 114 includes a vibration motor 118, 218, 318 (e.g., FIGS. 13-15) that, when electrically operated, causes the cover panel 116 and/or outer surface of the vehicle 10 surrounding the cover panel 116 to vibrate, thus breaking and/or loosening ice build-up present at the outer surface of the cover panel 116. Thus, when ice build-up is present at the outer surface of the cover panel 116 and with the cover panel in the closed position, the vibration motor may be electrically operated before and/or during an opening process to break and/or loosen the ice build-up so that the actuator 111 of the charge port 112 may more easily move the cover panel toward the opened position.

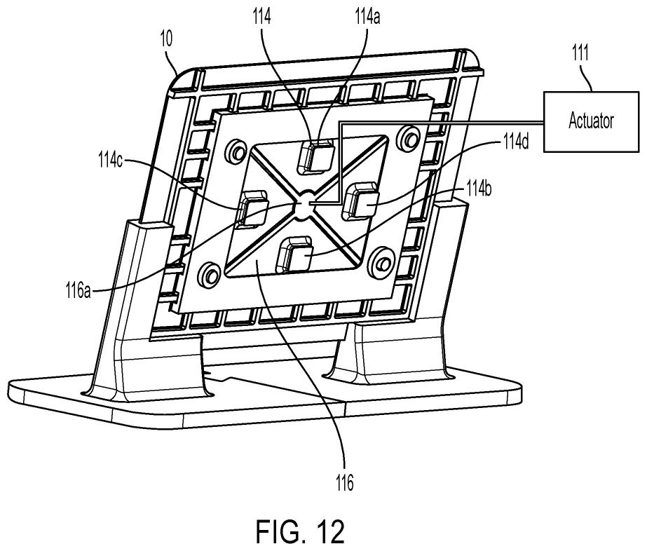

The one or more vibration modules 114 are disposed at an inner surface or side of the cover panel 116 and/or the body panel of the vehicle 10 at or near the charge port 112. For example, and as shown in FIG. 12, a first vibration device or module 114a is disposed along an upper edge region at the inner side of the cover panel 116, a second vibration device or module 114b is disposed along a lower edge region at the inner side of the cover panel 116, a third vibration device or module 114c is disposed along a first side edge region (e.g., left in FIG. 12) at the inner side of the cover panel 116, and a fourth vibration device or module 114d is disposed along a second side edge region (e.g., right in FIG. 12) at the inner side of the cover panel 116. Although shown with four vibration modules 114, it should be understood that the charge port 112 may include any suitable number of vibration modules disposed at any suitable position relative to the cover panel 116, such as one vibration module disposed along an edge of the cover panel or at a central portion of the cover panel.

Each vibration module 114 includes a respective electrically operable motor 118, 218, 318 that is operable to impart vibration of the cover panel 116 and/or surface of the vehicle 10 at or near the charge port 112 when operated. The one or more vibration motors may be mounted at the cover panel 116 with a back plate or rear housing attached to the cover panel (such as via four-way locator pins at the corner regions of the cover panel) to accommodate the one or more motors between the cover panel and the back plate. The one or more vibration modules 114 may include any suitable type of vibration motor, such as a vibration motor 118 having an eccentric rotating mass (FIG. 13), a linear resonant actuator 218 (FIG. 14), a solenoid actuator 318 (FIG. 15), a piezoelectric motor, and the like.

When the cover panel 116 is in the closed position, the one or more vibration modules 114 are actuated to vibrate the cover panel 116 and/or area surrounding the cover panel 116 to remove and/or loosen ice build-up at the outer surface of the cover panel 116. In the illustrated example, the first vibration module 114a, the second vibration module 114b, the third vibration module 114c and the fourth vibration module 114d may be actuated simultaneously or in any suitable order or combination. For example, the vibration modules 114 may be pulsed or episodically operated in a circular pattern (e.g., clockwise in FIG. 12) so that different portions of the cover panel 116 are vibrated as the vibration modules 114 are operated.

Operation of the one or more vibration modules 114 may be controlled by a controller or electronic control unit (ECU) of the charge port 112 (or a central controller of the vehicle), the ECU having electronic circuitry and associated software. For example, the vibration module 114 may be operated in response to a user input, such as a user input at the interior portion of the vehicle or a user input at a keyfob associated with the charge port system 112. Optionally, the vibration module 114 may be operated to remove ice build-up from the exterior of the cover panel 116 in response to one or more sensors or ice measurement markers 120 at the outer surface of the cover panel 116 and/or outer surface of the vehicle 10 at or near the charge port 112. Thus, the electronic circuitry of the ECU may include a data processor that is operable to process sensor data captured by the one or more sensors 120 for determining whether to operate the one or more vibration modules 114. The data transfer or signal communication between the vibration module 114, the sensor 120, and/or the ECU may comprise any suitable data or communication link, such as a vehicle network bus or the like of the equipped vehicle.

The sensor 120 may include any suitable sensor for detecting presence of ice at or near the cover panel 116. For example, the sensor 120 may include radar, lidar, a temperature sensor, and/or an imaging sensor or camera that views the outer surface of the cover panel (e.g., a camera disposed at an exterior rearview mirror assembly and viewing the exterior surface of the cover panel). When, based on sensor data captured by the sensor 120, the system determines that ice is present at the outer surface of the cover panel 116, the charge port system 112 may operate the one or more vibration modules 114 to remove and/or loosen ice at the outer surface of the cover panel 116. Optionally, the system 112 may operate the vibration module 114 based on the temperature at the exterior of the vehicle being below a threshold temperature (e.g., below 32 degrees Fahrenheit, below 20 degrees Fahrenheit, below 0 degrees Fahrenheit, and the like) because ice is more likely to be present at the cover panel in freezing conditions.

For example, when the user provides a user input to open the cover panel 116, the system may first determine whether ice is present (or likely to be present if based on temperature) at the outer surface of the cover panel 116. Based on determination that ice is present (or likely to be present) at the outer surface of the cover panel 116, the system operates the one or more vibration modules 114 to remove the ice and the system operates the actuator to move the cover panel from the closed position toward the opened position. The system may not operate the vibration module in situations where it is determined that ice is not present (or not likely to be present), such as when captured sensor data is not indicative of ice present at the exterior surface of the cover panel or when the temperature exterior of the vehicle is above the threshold temperature. Optionally, the system may actuate the vibration module 114 each time the charge port actuator is operated to move the cover panel from the closed position toward the opened position.

Optionally, the system may determine a torque load at the actuator, such as by measuring a force imparted by the actuator on the cover panel, such as at a contact surface or contact region 116a of the cover panel where the actuator engages the cover panel 116. Thus, when the torque load at the actuator is greater than a threshold torque load, the system may determine that ice is present at the outer surface of the cover panel 116 and actuate the vibration module 114 to loosen and/or remove the ice build-up from the cover panel 116. Optionally, the system detects a location or position of the ice at the outer surface of the cover panel 116 (e.g., along an upper edge region of the cover panel) and actuates one or more vibration modules 114 that correspond to the location of the ice at the outer surface of the cover panel (e.g., the first vibration module 114a corresponding to the upper edge region of the cover panel).

The charge port actuator may include a clutch or slip element so that, when the charge port actuator is operated to move the cover panel 116 from the closed position toward the opened position and a torque load at the cover panel 116 exceeds a maximum torque load of the actuator (e.g., such as due to ice build-up), the clutch element allows the output element of the actuator to slip relative to the motor of the actuator to preclude or reduce damage to the motor. The actuator may further include a position sensor (such as a potentiometer at the actuator) for determining position of the cover panel between the closed position and the opened position. Thus, when the actuator is actuated to move the cover panel from the closed position toward the opened position, yet the position sensor does not detect movement of the cover panel, the system may determine that the clutch element is slipping relative to the motor and thus determine presence of ice at the outer surface of the cover panel. In response to determining presence of ice at the outer surface of the cover panel, the system may actuate the vibration module 114.

The vibration module 114 may be operated to vibrate the cover panel 116 at any suitable frequency or in any suitable pattern or according to any suitable program. For example, when operated, the vibration module 114 may be actuated to continuously vibrate the cover panel or the vibration module may be actuated at a regular interval to pulse or buzz the cover panel 116. The vibration module 114 may be actuated at varying intensities and for varying intervals of time. For example, the vibration module 114 may be progressively actuated at increasing intensities and/or for increasing intervals of time until the system determines that ice is cracked or broken or no longer present at the cover panel and the cover panel may be moved from the closed position toward the opened position. Moreover, the vibration module 114 may be actuated at any suitable frequency and/or intensity, such as a lower frequency at a higher intensity or a higher frequency at a lower intensity. Optionally, the cover panel 116 may be vibrated at a frequency at or near the natural frequency of the cover panel 116, causing the cover panel 116 to resonate.

Further, the cover panel 116 may comprise a variable sheet-metal component for gap adjustment so that gaps between the cover panel 116 and the surface of the vehicle 10 at the charge port 112 may be adjusted to control ice build-up at the gaps. A peripheral lip or edge 122 of the outer surface of the vehicle 10 surrounding the cover panel 116 may be drafted out to drain water toward the cover panel door or outer surface of the vehicle to reduce ice build-up at the outer surface of the cover panel.

Thus, the charge port 112 includes a cover panel 116 and one or more vibration modules 114 including respective vibration motors at an inner or interior facing surface of the cover panel 116. When the cover panel 116 is in the closed position and ice is present at the outer surface of the cover panel 116 that may prevent the cover panel 116 from moving toward the opened position, the vibration module 114 is actuated to loosen and/or remove ice build-up at the outer surface of the cover panel 116. With the ice build-up cracked and/or loosened and/or removed, the actuator of the charge port may move the cover panel from the closed position and toward the opened position. The vibration modules 114 may be actuated each time the cover panel is moved from the closed position toward the opened position. Optionally, the vibration modules 114 are operated in response to an input, such as a user input or based on determination that ice is present at the outer surface of the cover panel 116.

That is, the charge port provides vibratory excitation at or near the cover panel and charge port to break ice around the cover panel or door. The system includes one or more vibration motors, which may be similar to those found in a gaming console controller, a cell-phone, or an electric toothbrush based on energy needs for the system, and an inverse sine sweep. In the illustrated example (e.g., FIG. 12), the charge port includes four vibration motors (such as one along each edge of the cover panel) and the vibration motors may be turned on individually and in any suitable combination. Optionally, the system includes one motor on the door at any suitable placement for the motor to break the ice. The natural frequency of the cover panel that is iced over could be met and followed as the resonant frequency decreases, thus exciting that frequency and causing the cover panel to resonate and break free of the ice resisting movement of the cover panel.

The charge port with vibration module provides improved charge port performance as the vibration module consumes less energy than that of an electrical heating element for removing similar ice build-up and the vibration module consumes less energy than a higher torque motor for breaking through similar ice build-up. Further, the charge port with the vibration module has lower engineering costs than creating a torque multiplier and can be modified or adapted to a particular cover panel or vehicular component more easily. Further, the vibration module breaks or loosens the ice build-up in less time than alternative methods. The vibration module thus allows a lower torque (and thus lower cost) motor to be used when a higher torque (and thus higher cost) motor may otherwise be required.

Although the vibration module and actuator are described as suitable for use with a vehicular charge port, the vibration module and actuator may be suitable for use with any exterior vehicular component that is movable between positions and that may be precluded from moving between positions due to ice build-up or other resistance loads at the vehicular component. For example, the actuator and/or vibration module may be integrated with a vehicular powerfold exterior rearview mirror assembly that is electrically operable to move between an extended or use position and a folded or non-use position at the side of the vehicle. The vibration module may be operated to loosen or break ice present at the exterior rearview mirror so that the powerfold actuator may move the mirror between the extended and folded positions. Optionally, the actuator and/or vibration module may be integrated with a vehicular flush door handle assembly that is movable between a flush or non-graspable position and an extended or graspable position at a closure panel of the vehicle (e.g., a door, a liftgate, a tailgate, and the like). The vibration module may be operated to loosen or break ice present at the exterior surface of the flush door handle so that the door handle may be moved between the flush and extended positions.

The charge ports described herein may be illuminated via any suitable means, and may utilize aspects of the charge ports and systems described in U.S. Pat. No. 8,317,376 and/or U.S. Publication No. US-2023-0191926, which are hereby incorporated herein by reference in their entireties. The vehicle may include various indicators to indicate the charge level of the vehicle, such as by utilizing aspects of the systems described in U.S. Pat. No. 10,746,575 and/or U.S. Publication No. US 2021/0129757, which are hereby incorporated herein by reference in their entireties.

Optionally, the system and cover may operate to provide autonomous charging and may open the cover panel and pivot or move the charging connector responsive to determination of presence of the charging wand, and may control movement of the charging wand to guide the wand into electrical connection with the charging connector when the panel is opened and the connector is pivoted or moved to its charging position. The system may provide a passive way of charging electric vehicles (or plug-in hybrid vehicles or PHEVs) assisted by ultra-wideband (UWB) time of flight distance measurements (which may be made via processing of data captured by one or more time of flight sensors and/or transmitters disposed at the vehicle charge port and/or sensing or communicating with the charging wand), such as by utilizing aspects of the systems described in U.S. Publication No. US-2023-0133911, which is hereby incorporated herein by reference in its entirety. A communication gateway in communication with a PCF may automatically establish a connection with the charging station the electric vehicle is parked at. This automates the process of charging the vehicles (i.e., reduces or eliminates human intervention). The system allows for the charging station plug of the charging station to be guided to the charging socket of the electric vehicle using range and vector communication supplied by a UWB antenna system.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular charge port closure system, the vehicular charge port closure system comprising:
a cover panel disposed at a vehicle equipped with the vehicular charge port closure system, wherein the cover panel is movable between (i) a closed position where the cover panel conceals a charge port of the vehicle and (ii) an opened position where the cover panel is positioned to allow access to a charging connector of the charge port;
a deployment mechanism operable to move the cover panel between the closed position and the opened position;
an ice-breaking mechanism disposed at the cover panel; and
wherein, when ice is present at a peripheral edge of the cover panel that limits movement of the cover panel from the closed position toward the opened position, the ice-breaking mechanism is operable to break the ice from the peripheral edge of the cover panel so that the cover panel is movable from the closed position toward the opened position.

2. The vehicular charge port closure system of claim 1, wherein the ice-breaking mechanism comprises (i) an output element disposed at least partially outboard of the peripheral edge of the cover panel and (ii) an electrically operable actuator that is electrically operated to move the output element, and wherein, with the cover panel in the closed position, the output element is movable between a retracted position, where the output element is disposed inboard of an outer side of the cover panel, and an extended position, where the output element is moved from the retracted position and toward the outer side of the cover panel, and wherein the electrically operable actuator is electrically operated to move the output element from the retracted position toward the extended position so that the output element engages and breaks the ice as the output element moves toward the extended position.

3. The vehicular charge port closure system of claim 2, wherein, when the electrically operable actuator is electrically operated, the electrically operable actuator rotatably drives a cam that engages the output element, and wherein, as the electrically operable actuator rotatably drives the cam, the output element rides an outer surface of the cam and moves between the retracted position and the extended position according to a position of the output element at the outer surface of the cam.

4. The vehicular charge port closure system of claim 3, wherein the cam comprises a spiral cam having a variable radius.

5. The vehicular charge port closure system of claim 3, wherein the output element comprises (i) a first portion that engages the outer surface of the cam and (ii) a second portion that extends from the first portion and outboard of the peripheral edge of the cover panel, and wherein, as the output element moves from the retracted position toward the extended position, an end of the second portion opposite the first portion engages the ice at the peripheral edge of the cover panel.

6. The vehicular charge port closure system of claim 5, wherein, as the output element moves from the retracted position toward the extended position, the first portion of the output element engages an inner side of the cover panel to urge the cover panel from the closed position toward the opened position.

7. The vehicular charge port closure system of claim 5, wherein the end of the second portion comprises a sharpened and rigid tip.

8. The vehicular charge port closure system of claim 5, wherein the end of the second portion comprises a flexible tip.

9. The vehicular charge port closure system of claim 1, wherein the ice-breaking mechanism comprises a cord and a tab attached at a first end of the cord, and wherein a second end of the cord opposite the first end is attached at an inner side of the cover panel, and wherein, with the cover panel in the closed position, the ice-breaking mechanism is manually operated by moving the tab between (i) a first position, where the tab is removably attached at an outer side of the cover panel, and (ii) a second position, where the tab is removed from the outer side of the cover panel and spaced from the cover panel and the cord extends between the inner side of the cover panel and the tab and outboard of the peripheral edge of the cover panel, and wherein the tab is manually movable from the second position to move the cord relative to the peripheral edge of the cover panel so that the cord engages and breaks the ice from the peripheral edge of the cover panel.

10. The vehicular charge port closure system of claim 9, wherein the second end of the cord is attached at a reel mechanism at the inner side of the cover panel, and wherein the reel mechanism biases the cord to urge the tab toward the first position.

11. The vehicular charge port closure system of claim 1, wherein a graspable door is pivotably disposed at an outer side of the cover panel, and wherein the graspable door is movable between (i) a recessed position, where the graspable door is at least partially recessed into the outer side of the cover panel, and (ii) an extended position, where the graspable door is pivoted outward from the recessed position and is spaced from the outer side of the cover panel, and wherein, when the graspable door is in the extended position and with the cover panel in the closed position, the graspable door is graspable by a user to manually move the cover panel from the closed position toward the opened position.

12. The vehicular charge port closure system of claim 11, wherein an electrically operable actuator, when electrically operated, drives an output element that engages the graspable door to move the graspable door between the recessed position and the extended position.

13. The vehicular charge port closure system of claim 12, wherein the output element comprises a plunger that is linearly driven by the electrically operable actuator.

14. The vehicular charge port closure system of claim 12, wherein the output element comprises a cam that is rotatably driven by the electrically operable actuator.

15. The vehicular charge port closure system of claim 12, wherein, with ice present at the peripheral edge of the cover panel, the ice-breaking mechanism is moved responsive to the deployment mechanism failing to move the cover panel from the closed position toward the opened position.

16. The vehicular charge port closure system of claim 1, wherein the ice-breaking mechanism comprises a vibration device that is electrically operable to impart vibratory movement of the cover panel to break the ice.

17. A vehicular charge port closure system, the vehicular charge port closure system comprising:
a cover panel disposed at a vehicle equipped with the vehicular charge port closure system, wherein the cover panel is movable between (i) a closed position where the cover panel conceals a charge port of the vehicle and (ii) an opened position where the cover panel is positioned to allow access to a charging connector of the charge port;
a vibration device that is electrically operable to impart vibration of the cover panel; and
wherein, when ice is present at an outer side of the cover panel that limits movement of the cover panel from the closed position toward the opened position, the vibration device is electrically operated to impart vibration of the cover panel to break the ice from the outer side of the cover panel so that the cover panel is movable from the closed position toward the opened position.

18. The vehicular charge port closure system of claim 17, wherein the vibration device is disposed at an inner side of the cover panel, and wherein the inner side of the cover panel is opposite the outer side of the cover panel.

19. The vehicular charge port closure system of claim 17, wherein the vibration device comprises an electrically operable vibration motor that, when electrically operated, imparts vibration of the cover panel.

20. The vehicular charge port closure system of claim 19, wherein the electrically operable vibration motor comprises an eccentric rotating mass.

21. The vehicular charge port closure system of claim 19, wherein the electrically operable vibration motor comprises a linear resonant actuator.

22. The vehicular charge port closure system of claim 19, wherein the electrically operable vibration motor comprises a solenoid actuator.

23. The vehicular charge port closure system of claim 17, wherein the vibration device comprises a plurality of electrically operable vibration motors, and wherein, when one electrically operable vibration motor of the plurality of electrically operable vibration motors is electrically operated, the one electrically operable vibration motor of the plurality of electrically operable vibration motors imparts vibration of the cover panel.

24. The vehicular charge port closure system of claim 23, wherein, when the vibration device is electrically operated to impart vibration of the cover panel, each electrically operable vibration motor of the plurality of electrically operable vibration motors is electrically operated.

25. The vehicular charge port closure system of claim 23, wherein, when the vibration device is electrically operated to impart vibration of the cover panel, only one electrically operable vibration motor of the plurality of electrically operable vibration motors is electrically operated.

26. The vehicular charge port closure system of claim 25, wherein the one electrically operable vibration motor of the plurality of electrically operable vibration motors is electrically operated based on a determined position of the ice at the outer side of the cover panel corresponding to a position of the one electrically operable vibration motor at the cover panel.

27. The vehicular charge port closure system of claim 17, wherein, with the cover panel in the closed position, the vibration device is electrically operated to impart vibration of the cover panel responsive to determination that the ice is present at the outer side of the cover panel.

28. The vehicular charge port closure system of claim 27, wherein the vehicular closure system determines presence of the ice at the outer side of the cover panel based on sensor data captured by a sensor disposed at the vehicle at or near the charge port of the vehicle.

29. The vehicular charge port closure system of claim 17, wherein the vibration device imparts vibrations of the cover panel at a frequency based on a natural frequency of the cover panel.

30. The vehicular charge port closure system of claim 17, wherein a sealing element is disposed at the cover panel, and wherein, when the cover panel is in the closed position, the cover panel compresses the sealing element.

31. The vehicular charge port closure system of claim 17, further comprising an actuator that is electrically operable to move the cover panel between the closed position and the opened position.

32. The vehicular charge port closure system of claim 17, wherein the cover panel is manually movable between the closed position and the opened position.

33. A vehicular charge port closure system, the vehicular charge port closure system comprising:
a cover panel disposed at a vehicle equipped with the vehicular charge port closure system, wherein the cover panel is movable between (i) a closed position where the cover panel conceals a charge port of the vehicle and (ii) an opened position where the cover panel is positioned to allow access to a charging connector of the charge port;
a first electrically operable actuator that is electrically operable to move the cover panel between the closed position and the opened position;
an ice-breaking mechanism disposed at the cover panel;
wherein the ice-breaking mechanism comprises (i) an output element disposed at least partially outboard of the peripheral edge of the cover panel and (ii) a second electrically operable actuator that is electrically operated to move the output element;
wherein, with the cover panel in the closed position, the output element is movable between (i) a retracted position, where the output element is disposed inboard of an outer side of the cover panel, and (ii) an extended position, where the output element is moved from the retracted position and toward the outer side of the cover panel;
wherein, when ice is present at a peripheral edge of the cover panel that limits movement of the cover panel from the closed position toward the opened position, the second electrically operable actuator is electrically operated to move the output element from the retracted position toward the extended position so that the output element engages and breaks the ice as the output element moves toward the extended position; and
wherein, with ice present at the peripheral edge of the cover panel, the second electrically operable actuator operates responsive to failing to move the cover panel from the closed position toward the opened position via operation of the first electrically operable actuator.

34. The vehicular charge port closure system of claim 33, wherein, when the second electrically operable actuator is electrically operated, the second electrically operable actuator rotatably drives a cam that engages the output element, and wherein, as the second electrically operable actuator rotatably drives the cam, the output element rides an outer surface of the cam and moves between the retracted position and the extended position according to a position of the output element at the outer surface of the cam.

35. The vehicular charge port closure system of claim 34, wherein the cam comprises a spiral cam having a variable radius.

36. The vehicular charge port closure system of claim 34, wherein the output element comprises (i) a first portion that engages the outer surface of the cam and (ii) a second portion that extends from the first portion and outboard of the peripheral edge of the cover panel, and wherein, as the output element moves from the retracted position toward the extended position, an end of the second portion opposite the first portion engages the ice at the peripheral edge of the cover panel.

37. The vehicular charge port closure system of claim 36, wherein, as the output element moves from the retracted position toward the extended position, the first portion of the output element engages an inner side of the cover panel to urge the cover panel from the closed position toward the opened position.

38. The vehicular charge port closure system of claim 36, wherein the end of the second portion comprises at least one selected from the group consisting of (i) a sharpened tip, (ii) a rigid tip and (iii) a flexible tip.

39. The vehicular charge port closure system of claim 33, wherein a graspable door is pivotably disposed at an outer side of the cover panel, and wherein the graspable door is movable between (i) a recessed position, where the graspable door is at least partially recessed into the outer side of the cover panel, and (ii) an extended position, where the graspable door is pivoted outward from the recessed position and is spaced from the outer side of the cover panel, and wherein, when the graspable door is in the extended position and with the cover panel in the closed position, the graspable door is graspable by a user to manually move the cover panel from the closed position toward the opened position.

40. The vehicular charge port closure system of claim 39, wherein a third electrically operable actuator, when electrically operated, drives an output element that engages the graspable door to move the graspable door between the recessed position and the extended position.

41. The vehicular charge port closure system of claim 40, wherein the output element comprises a plunger that is linearly driven by the third electrically operable actuator.

42. The vehicular charge port closure system of claim 40, wherein the output element comprises a cam that is rotatably driven by the third electrically operable actuator.
